(19) United States
(12) Patent Application Publication
(10) Pub. No.: US 2022/0211005 A1
(43) Pub. Date: Jul. 7, 2022

(54) Device for Receiving Excrement in a Container Which Can Be Provided Automatically, Such a Container, and Storage Device for Such a Container

(71) Applicants: Machiel Ruijterkamp, Arth (CH); Arjen Verschuure, Hoofddorp (NL)

(72) Inventors: Machiel Ruijterkamp, Arth (CH); Arjen Verschuure, Hoofddorp (NL)

(21) Appl. No.: 17/614,224

(22) PCT Filed: May 25, 2020
(86) PCT No.: PCT/EP2020/064436

§ 371 Date: Nov. 24, 2021

(30) Foreign Application Priority Data
May 27, 2019 (EP) 19176767.2

(51) Int. Cl. A01K 23/00; A01K 27/00

(52) U.S. Cl. CPC A01K 23/005; A01K 27/004

(57) ABSTRACT

A container for receiving and disposing of excrement is disclosed. The container has a container wall designed in the shape of a bag, with a base and, lying opposite the latter, an edge forming a receiving opening of the container. An elastic element provided at the edge serves to stretch out the receiving opening and to stiffen the edge. The container also has a device for closing the receiving opening, wherein the edge can be pulled shut by pulling on the elastic element. Also disclosed are a storage unit for receiving, storing and making available such a container, a device with such a storage unit for receiving and handling excrement, and a roll-up dog leash having such a device.

### CROSS-REFERENCE TO RELATED APPLICATIONS

This application is the United States national phase of International Application No. PCT/EP2020/064436 filed May 25, 2020, and claims priority to European Patent Application No. 19176767.2 filed May 27, 2019, the disclosures of which are hereby incorporated by reference in their entirety.

### BACKGROUND OF THE INVENTION

### Field of the Invention

The present invention relates to a container, in particular a bag or a pouch, for excrements, a storage device for automatically providing at least one such container, and a device for receiving and handling excrements in a container from the storage device.

Excrements in the sense of the present invention are animal products of defecation from the gastrointestinal tract, in particular dog faeces. However, the present invention can also be used to receive other products, for example smaller waste, which are suitable for handling with the container according to the invention.

### Description of Related Art

Dog owners are generally required to disposing of their dog's waste themselves. The disposal is mainly done after the dog has done its business directly on the ground, by picking up the excrement from the ground again and transporting it into a dog excrement bag carried by the dog owner itself or provided publicly for this purpose. This is done, for example, with a shovel that the dog owner has also brought himself or by putting the dog excrement bag on like a glove, grabbing the excrement with it and then turning the bag inside out.

Many people find this method of excrement disposal unpleasant and embarrassing. In addition, picking up the faeces by hand requires stooping down to the ground, which can be cumbersome and tedious, especially if the person picking up the faeces is in poor health or is carrying bags or luggage. Furthermore, both hands are necessary to carry the faeces into the bag and to close the bag. A particular disadvantage here is that a dog owner cannot keep an eye on the dog and/or have the dog leash under control at the same time while stooping to collect excrement.

Devices are already known that deal with this problem.

DE 10 2017 005 058 A1 discloses a hand-held device for picking up and transporting dog excrement. The hand-held device has a telescopic tube system, at the lower end of which a gripper system is provided. The gripper system is connected to a cable pull mechanism. By pulling on the cable, the grippers take hold of the excrements lying on the ground and lift them upwards into the tube system. With this solution, the excreta must be disposed of separately in a toilet and the device must be cleaned afterwards. Also, only one pile of excrement can be picked up with this device.

DE 10 2012 103 071 A1 discloses a dog excrement collector formed of a rod with a handle and a tip. The body of the rod consists of two tubes forming two telescopically connected sections and has, slightly above the tip, a ring which is oriented horizontally when the rod is in the extended position to receive the dog's excrement at the moment the animal defecates. Around the ring, the opening of a plastic bag is attached with the help of a rubber band. The rubber band is also used to close the bag once the collection process is finished. The excrement collector is further provided with a tubular container for plastic bags, which is attached to the handle of the rod by means of a thread or by a pressure system, and which has an opening through which the bags can be removed as required, in the manner of a wipes box. It is true that this device makes it easier to pick up the faeces by letting the dog do its business directly in the bag. However, it is necessary to insert the bag into the ring by hand and to fasten it. The bag must also be removed from the device and closed by hand. This again requires both hands, which can lead to the aforementioned problems.

WO 2013/114354 A1 discloses a device for picking up dog excrement, which is integrated into a roller leash box. The device has a gripper device provided on a telescopic rod, which is electrically operated to move out of and into the leash box. Also electrically operated, the gripper blades open and close in order to grip and pick up excrements lying on the ground. With this device, the excrements have to be disposed of separately in a toilet and the grippers have to be cleaned afterwards. To reduce the cleaning effort of the blades, a foil or pouch can be attached to the inside of the gripper blades. In this case, however, the foil or pouch must be applied separately by hand before the excrements are picked up and removed afterwards and also disposed of.

### SUMMARY OF THE INVENTION

Based on the aforementioned prior art, it is therefore the object of the invention to provide a device for receiving excrements which can be operated as easily as possible, in particular with one hand and without having to bend down. In particular, the device should make it possible to pick up, transport and dispose of excrements without having to touch a container for the excrements with the hands. A further object is to provide a corresponding receiving container and a storage device for this purpose.

In order to achieve this object, a container for receiving and disposing of excrements is provided, which has a bag-shaped container wall with a bottom and a rim opposite the latter and forming a receiving opening of the container, as well as an elastic element provided on the rim for stretching open the receiving opening and for stiffening the rim, and a device for closing the receiving opening, wherein the rim can be pulled closed by pulling on the elastic element.

Preferably, the container is a bag, sachet or pouch or similar container having a preferably round or rectangular, in particular square, cross-section. The container is dimensioned in such a way that excrements, in particular from dogs, can be easily and safely collected.

Preferably, the container or the container wall comprises a waterproof material or the container wall is coated with a waterproof material on its inner surface and/or outer surface. Particularly preferably, the container wall consists of a plastic foil, e.g. polyethylene or polypropylene. Advantageously, the container wall is largely, i.e. more than 50% by weight, preferably more than 70% by weight, even more preferably more than 90% by weight or even 100% by weight, made from renewable raw materials and/or is biodegradable.

The spatial shape of the elastic element expediently corresponds to the spatial shape of the container cross-section. Preferably, the elastic element is an elastic ring or an elastic element with an overall rectangular shape. However, the elastic element may also have any other shape, such as an oval shape or a polygonal shape, in particular a hexagonal shape.

Preferably, the elastic element has a diameter that is slightly smaller or larger than the diameter of the container or the rim of the container. The same applies to length and width in the case of a rectangular element. Accordingly, the elastic element is arranged inside or outside in relation to the container wall.

The elastic element is preferably a moulded plastic part, the material being chosen such that the elastic element is deformable, e.g. foldable or twistable, but at the same time has the tendency to return to its original spatial shape, i.e. to spring back from the folded shape into an e.g. annular shape. However, the elastic element can also be made of any other material, such as in particular a metal. Advantageously, the elastic element is largely, i.e. more than 50% by weight, preferably more than 70% by weight, even more preferably more than 90% by weight or even 100% by weight, made from renewable raw materials and/or is biodegradable.

Preferably, the elastic element can be formed into the shape of a twisted folded figure of eight.

Preferably, the elastic element is arranged along the rim and connected thereto, so that the elastic element is freely movable in the radial direction relative to the rim, but is substantially limited or fixed perpendicularly thereto, i.e. in the axial direction of the container. In a preferred embodiment, the rim is folded around the elastic element and fixed, e.g. glued, to the container wall so that a channel is formed in which the elastic element is freely displaceable radially. The elastic element can also be fastened by means of loops or eyelets.

Due to the nature and arrangement of the elastic element, the receiving opening of the container is automatically stretched open. In addition, the container is stiffened or self-supporting in the rim area so that the rim does not fold away when the container is used. This makes it possible to pick up excrements from the floor and also to catch them directly in the course of business, even before they touch the floor. Furthermore, the elastic element is foldable, i.e. it can be folded for storage or twisted or folded over so that the space requirement is reduced. In this case, the elastic element pops up again during removal and stretches open the container as explained.

According to a preferred embodiment, the device for closing the receiving opening comprises a holding element connected to the elastic element, and a locking element provided on the holding element, wherein a tensile force pointing away from the elastic element in the radial direction can be applied to the holding element in such a way that the elastic element can be pulled out of the rim by pulling on the holding element relative to the locking element and can thereby be locked by the locking element.

Preferably, the holding element is a pin which is firmly connected to the elastic element, extends radially away and is round or rectangular in cross-section. Particularly preferably, the pin is integrally moulded to the elastic element.

Preferably, a recess is provided in the locking element for the holding element to be inserted through.

According to a preferred embodiment, the recess is smaller than the thickness of the holding element. Furthermore, the locking element preferably has a cut-out between the recess and a longitudinal edge. The two cut-outs are preferably identical and could extend, in particular centered and parallel to each other, each in a longitudinal extension of the metal plate. Furthermore, each cutout is connected to the recess so that two opposing elastic spring elements are formed by the cutouts and the recess. The spring elements each have a free end adjacent to the recess with a semi-circular end face advantageously corresponding to the recess. As a result, the end faces are bent backwards when the holding element is inserted through, so that they lock and the locking element can no longer be pulled off. Of course, the spring elements can also be arranged analogously with cutouts running in the width direction on the longitudinal sides.

In a preferred embodiment, the locking element is a small plate, in particular a rectangular plate, e.g. made of metal or plastic. Particularly preferably, the plate is concave in shape.

The locking element can be pushed onto the holding element but cannot be easily pulled off again. In the assembled state, the locking element is pushed onto the holding element up to the rim or the elastic element. In particular, the locking element in the form of the plate is pushed on with its concave side facing towards the container.

A storage device according to the invention for receiving, holding and in particular automatically providing a container according to the invention comprises a housing with a housing interior formed by a wall, a bottom and a lid, wherein one or more containers are received or can be received in the interior, and wherein the wall has a removal compartment accessible from the outside for automatically providing one of the containers.

The housing of the storage device may have any shape suitable for receiving the containers. In a preferred embodiment, the storage device has a housing in the form of a hollow cylinder, the hollow cylinder having a wall, a bottom and a lid, which surround a cylinder interior. However, the housing can also be designed as a hollow cuboid, for example. The container or containers are preferably received in the storage device or can be received therein in such a way that the elastic element is in its folded form, in particular assumes the form of a twisted folded figure of eight. The space required by the containers in the storage device can thus be considerably reduced.

Preferably, a first recess extending coplanar to the lid is provided in the wall in the region of the lid or of the bottom, preferably of the lid, the first recess being assigned to the removal compartment or the removal compartment being arranged after the first recess. A container located in the storage device can be removed from the removal compartment through the first recess.

Preferably, a second recess extending perpendicularly away from the first recess, in particular in the direction of the bottom, is also provided in the wall. The second recess is dimensioned in such a way that the holding elements of containers located in the storage device project beyond the wall and can be guided in the second recess.

Preferably, the second recess is enclosed by means of a shaft-like cover projecting from the wall. The cover is preferably U-shaped in cross-section and is arranged above the second recess in such a way that the holding elements, in particular holding pins, of containers located in the storage device are displaceably arranged within a shaft formed by the cover. Preferably, the cover is designed in such a way that only one holding element arranged in the removal compartment is accessible from the outside.

Preferably, the storage device comprises a reloading device preferably provided in the interior in the region of the bottom. By means of the reloading device, containers located in the interior can be automatically conveyed in the direction of the removal compartment. This means that a container can always be provided in the removal compartment.

Particularly preferably, the reloading device has a disc-shaped pressure plate extending parallel to the bottom and a drive device, in particular a spring or compression spring or hydraulic device, arranged between the pressure plate and the bottom and mounted on an inner side of the bottom. By means of the drive device, the pressure plate can be moved in the direction of the lid so that the uppermost container in the interior can be automatically conveyed into the removal compartment. In addition, the container in the removal compartment can be held in the removal compartment in such a way that it can be removed easily but cannot slip out by itself.

Preferably, a means for fastening or holding or coupling the storage device to a device which can be assigned to it, in particular a device for receiving excrements according to the invention, is formed on the lid of the storage device. This is, for example, a bayonet catch or snap-in catch or similar fastening means. Alternatively, the storage device can also be attached to the device for receiving excrements via its wall or its bottom. Preferably, the storage device is thus detachably attachable to the device for receiving excrements.

A device according to the invention for receiving and handling excrements, in particular in a container according to the invention, comprises a storage device for providing the container, an extendable and retractable tube arrangement, a container removal device for automated removal of the container from the storage device and conveyance of the container into a container holding device, and the container holding device for holding the container on an end wall of the tube arrangement and pulling the container closed.

Preferably, the tube arrangement has a plurality of tube segments which are connected to one another and can be extended from a device housing in a pull-out direction and retracted again, the foremost tube segment, as seen in the pull-out direction, comprising an end wall, an inner tube surface which tapers conically from the end wall counter to the pull-out direction as far as a tapered region, and a recess on its underside in the region of the conical inner tube surface.

Preferably, the container holding device comprises a clamping member with gripping means and a cable pulling mechanism with a pull cable and means for actuating the pull cable, wherein the clamping member and the pull cable are arranged reciprocally displaceable within the tube arrangement between a receiving position in which the gripping means is located in the region of the conical tube inner surface with a clamping region aligned with the recess in the tube, and a clamping position in which the gripping means is displaced into a rear region of the tube in a clamping manner with respect to the holding pin.

Preferably, the container removal device comprises at least one, preferably two, parallel removal arms which can be pivoted back and forth about a pivot axis in a pivoting direction and which each comprise a magnet at a free end facing away from the pivot axis, wherein the container removal device is adapted to the position of the removal compartment, and to the end wall of the tube segment, so that the removal arms are pivotable between a removal position, in which the removal arm in each case rests with the magnet against the locking element of the container which can be provided in the removal compartment, wherein the holding element engages through a through hole of the magnet, and a holding position, in which the holding element is insertable from below into the conical inner surface of the tube in the clamping region of the gripping means.

Preferably, the segments of the tube arrangement, the container removal device and the container holding device are each operable in an automated manner, in particular electrically. Preferably, a power supply is provided for this purpose, for example an accumulator or a battery. Particularly preferably, a means for energy recovery is provided, by means of which the battery can be recharged, e.g. when a dog leash associated with the device is unwound.

According to a further embodiment of the invention, a so-called roller dog leash, i.e. a dog leash that can be automatically unrolled or released for unrolling and rolled up again, is provided in the housing of the device. Such retractable dog leashes are known per se and can be combined in the known embodiments with the device according to the invention in a common housing. Alternatively, a device, for example a metal ring or a carabiner, for attaching a conventional leash, such as a leather leash or drag leash or short lead leash, may be provided on the housing of the device.

However, a roller dog leash can also be provided, in the housing of which the device according to the invention is integrated.

The advantage of the device according to the invention is thus the contactless pick-up, handling and disposal of the container and thus of the excrements. Further advantages are that the device can be operated with one hand, so that the dog leash does not have to be put away during the collection of the excrements. Furthermore, the device is compact and easy to manufacture as well as easy to operate. Furthermore, the device can be used flexibly due to the plurality of containers kept in stock and their automatic provision. There is no need for manual reloading or even cleaning. After all the containers held in the storage device have been used up, the now empty storage device can be conveniently replaced with a new storage device filled with containers due to its preferably detachable attachment.

### BRIEF DESCRIPTION OF THE DRAWINGS

Preferred embodiments of the invention are described below with reference to the drawings, which are for explanatory purposes only and are not to be construed restrictively. In the drawings are shown:

FIG. 1a a schematic top view of a container according to the invention;

FIG. 1b a schematic view of a holding device of a container according to the invention;

FIG. 1c a schematic, perspective view of a container according to the invention during assembly of the holding device;

FIG. 2a a schematic perspective view of a storage device according to the invention;

FIG. 2b a schematic sectional view of a storage device according to the invention with containers according to the invention;

FIG. 2c a front view of the storage device according to FIG. 2a;

FIG. 3 a schematic side view of a device according to the invention in partial view on telescopic arm in retracted position;

FIG. 4 a schematic perspective view of a device according to the invention in enlarged partial view of the storage device and pivot arms resting against a container;

FIG. 5 a schematic side view of a device according to the invention in partial view of telescopic arm in extended position;

FIG. 6 a schematic, sectional plan view of the end section of the telescopic arm with clamping element in the extended position;

FIG. 7 a schematic, sectional plan view of the end portion of the telescopic arm with pivot mechanism;

FIG. 8 a schematic, cutaway side view of the end section of the telescopic arm with pivot mechanism;

FIG. 9 a schematic, cutaway plan view of the end section of the telescopic arm with clamping element in retracted position;

FIG. 10 a schematic side view of a device according to the invention for picking up excrements, in the extended position;

FIG. 11 a schematic sectional view through the housing of the device;

FIG. 12 a schematic side view of the device for picking up excrements, in the retracted state and with a storage device attached to it; and

FIG. 13 a schematic side view of the device for collecting excrements, in the retracted state and with the storage device removed therefrom.

### DESCRIPTION OF THE INVENTION

In the various figures of the drawing, identical parts are always given the same reference signs. With regard to the following description, it is asserted that the invention is not limited to the embodiments and thereby not limited to all or several features of described combinations of features, rather each individual partial feature of the/each embodiment is also of significance for the object of the invention detached from all other partial features described in connection therewith, and also in combination with any features of another embodiment.

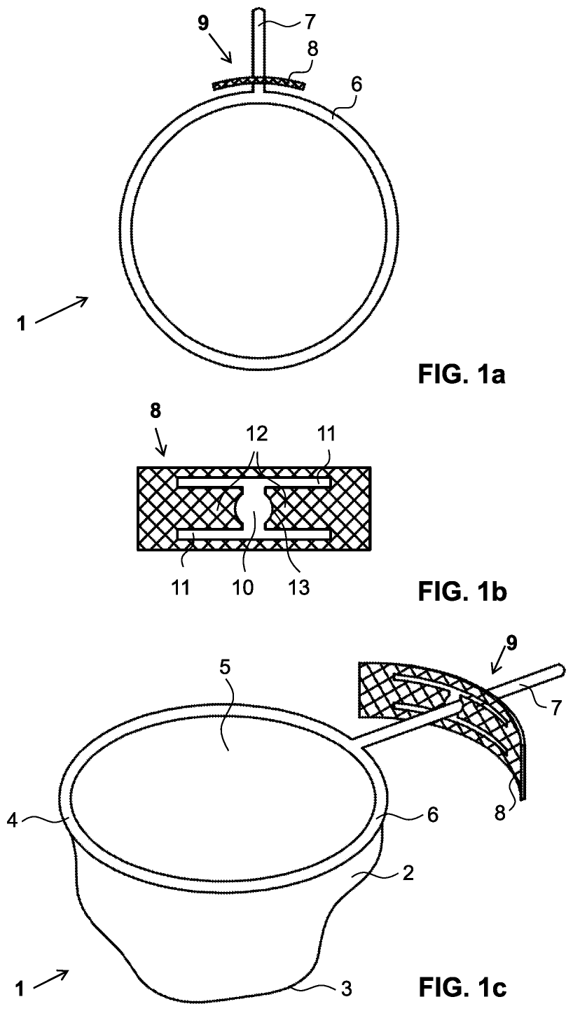

FIG. 1a shows an embodiment of a container 1 according to the invention for holding excrements. FIG. 1b shows an exemplary embodiment of a holding device 7 of the container 1 shown in FIG. 1a. FIG. 1c shows the container 1 during assembly of the holding device 7.

The container 1 for receiving and disposing of excrements has a container wall 2 with a bottom 3 and a rim 4. In the illustrated exemplary embodiment, the container wall 2 is formed from a plastic bag. The rim 4 forms or encloses a receiving opening 5 opposite the bottom 3. The container 1 further comprises an elastic element in the form of an elastic ring 6, a holding element 7 extending away from the elastic ring 6 in the radial direction and a locking element 8 provided on the holding element. Holding element 7 and locking element 8 form a device 9 for closing the receiving opening 5. The device 9 forms a part of the container 1.

The elastic ring 6 is made of plastic. However, it could in principle also be made of any other material, such as in particular a metal. The elastic ring 6 is attached to the rim 4, for example, by means of a loop channel formed by folding over the rim 4, and may be freely displaceable within the loop channel.

The holding element 7 is formed as a pin 7, preferably integrally formed on the elastic ring 6, which projects radially from the elastic ring 6 and protrudes from the rim 4.

The locking element 8 is a rectangular, concave shaped plate, preferably metal plate 8. The radius of the concavity is adapted to the radius of the elastic ring.

The metal plate 8 has a circular recess 10 in the center. Furthermore, the metal plate 8 has a cutout 11 between the recess 10 and a longitudinal edge. The two cutouts 11 are identical and extend centered and parallel to each other in a longitudinal extension of the metal plate 8. Furthermore, each cutout 11 is connected to the recess 10, so that two opposing elastic spring elements 12 are formed by the cutouts 11 and the recess 10. The spring elements 12 each have a free end adjacent to the recess 10 with a semicircular end face 13 corresponding to the recess.

The metal plate 8 is pushed completely onto the pin 7 by means of the recess 10 with its concave side pointing in the direction of the container 1 (see FIG. 1a). The pin 7 is clamped between the spring elements 12. The metal plate 8 is thus firmly attached to the container 1.

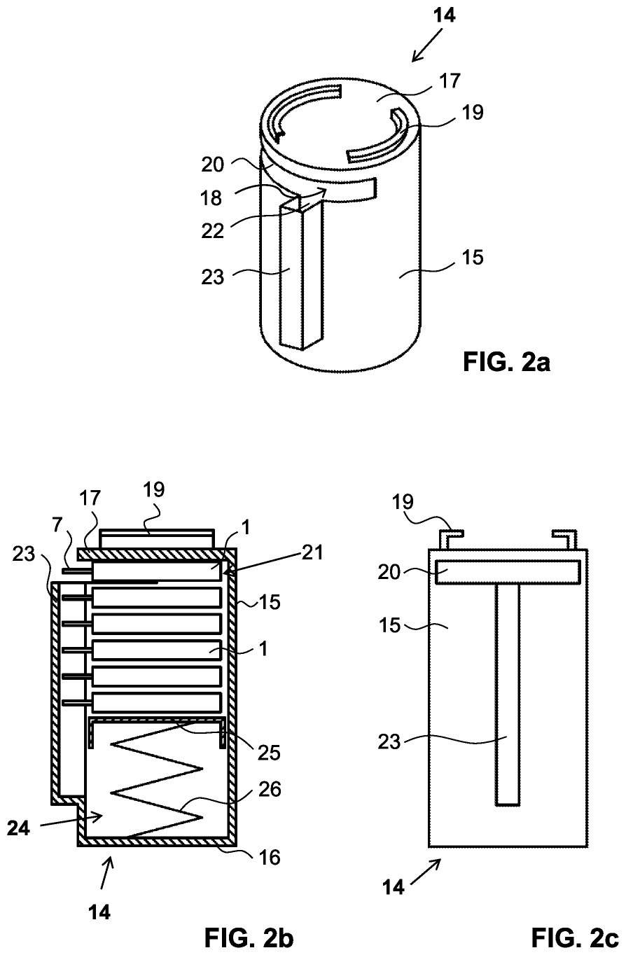

FIGS. 2a-c each show in different views an embodiment of a storage device 14 according to the invention for receiving, holding and in particular automatically providing one or more of the containers 1 shown in FIG. 1a.

The storage device 14 shown is in the form of a hollow cylinder, having a wall 15, a bottom 16 and a lid 17, which surround a cylinder interior 18.

The cylinder interior 18 is dimensioned such that several containers 1 can be received arranged one above the other. In particular, the cylinder interior 18 is adapted to a diameter of the containers 1, i.e. to a diameter of the elastic ring 6 or of the rim 4. The mentioned diameter of the elastic ring 6 may in particular and advantageously be the outer diameter of the elastic ring 6 in a folded shape, for example the shape of a twisted folded figure of eight.

A bayonet catch 19 is provided on the lid 17 for fastening or holding the storage device 14 to a device 27 for receiving excrements according to the invention.

In the region of the lid 17, the wall 15 has a first recess 20 extending parallel to the lid 17 with a removal compartment 21 being arranged behind the recess 20. The dimensions of the first recess 20 are adapted for removing a container 1 through the recess 20.

The wall 15 also has a second recess 22 extending perpendicularly from the first recess 20 towards the bottom 16. The second recess 22 has a width which is adapted to receive the holding pins 7. The holding pins 7 of containers 1 received in the storage device 14 project out of the second recess 22 over the wall 15. A cover 23 is moulded onto the wall 15 above the second recess 22 so that only the uppermost container 1 arranged on the lid side is accessible from the outside. The second recess 22 and the cover 23 thus form a bulge.

The removable container 1 is provided in the removal compartment 21. To accomplish this, a reloading device 24 is provided in the interior 18.

The reloading device 24 is designed to displace a container 1 with associated metal plate 8 into the removal compartment 21. In the present exemplary embodiment, the reloading device 24 has for this purpose a disc-shaped pressure plate 25 extending parallel to the bottom 16 and a compression spring 26 arranged between the pressure plate 25 and the bottom 16 and supported on an inner side of the bottom 16. By means of the pressure spring 26, the pressure plate 25 is driven in the direction of the lid 17 so that the uppermost container 1 located in the interior 18 is conveyed into the removal compartment 21 and held there.

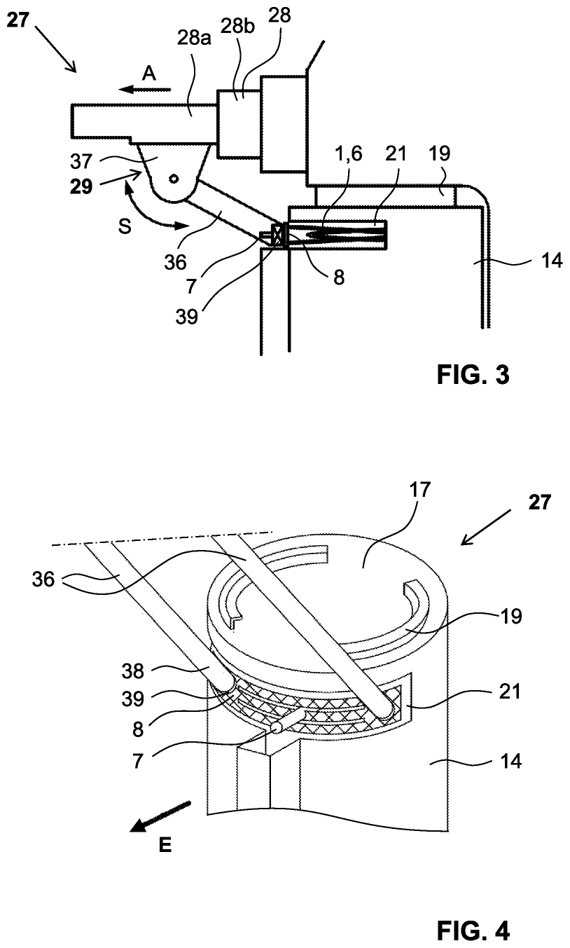

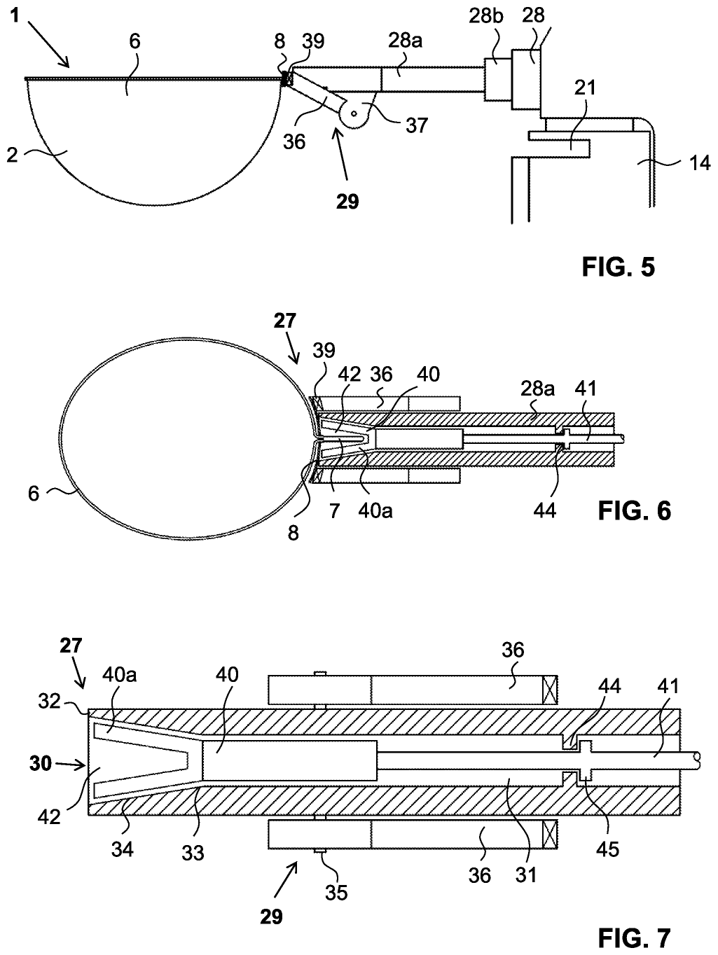

FIGS. 3 to 9 show partial views of various features of an exemplary embodiment of a device 27 according to the invention for receiving and handling excrements, in particular in the container 1 according to FIGS. 1a)-c) from the storage device 14 according to FIGS. 2a)-c).

The device 27 comprises a telescopic tube 28, a container removal device 29 and a container holding device 30, which are arranged in a housing (not shown). The device 27 further comprises the corresponding opposite 50 (see FIG. 11) of the bayonet catch 19 of the storage device 14 for fastening the storage device 14, which is preferably located on an underside of the telescopic tube 28.

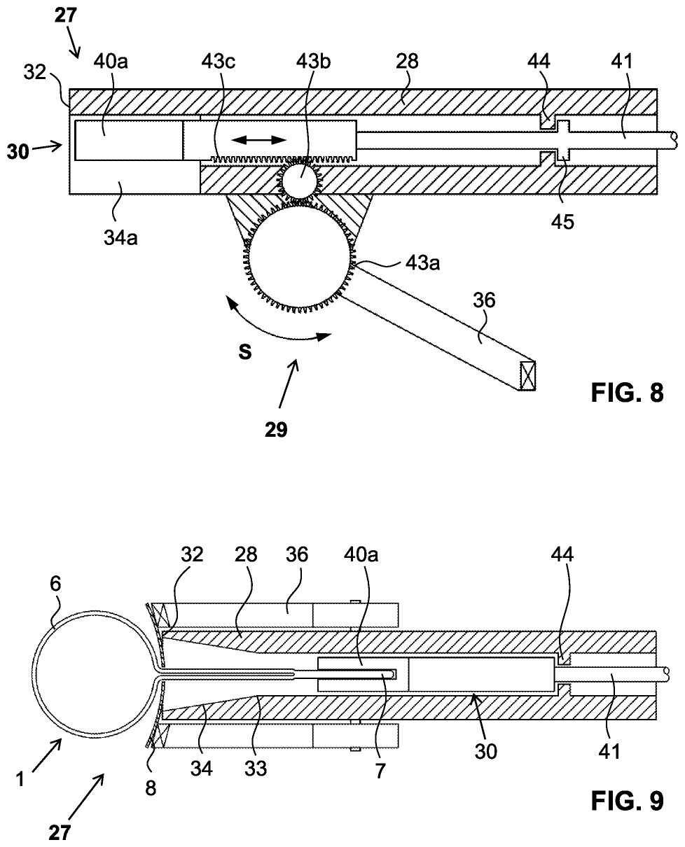

The telescopic tube 28 comprises a plurality of interconnected tube segments 28a, 28b which can be extended from the housing in a pull-out direction A and retracted again. The telescopic tube 28 is hollow on the inside and the individual tube segments 28a,b form a common tube interior 31. The foremost tube segment 28a, as seen in the pull-out direction A, comprises an end wall 32, a tube inner surface 34 tapering conically from the end wall 32 against the pull-out direction A to a tapered region 33, the inner diameter of the tube 28a at the end surface being larger than that at the tapered region 33, and a radial projection 44 arranged after the tapered region 33. Furthermore, the telescopic tube 28a has a recess 34a (FIG. 8) on its underside in the region of the conical inner tube surface 34 for receiving the holding pin 7. Furthermore, the telescopic tube can be extended by means of a release mechanism, e.g. electrically driven or by a spring.

The container removal device 29 has two parallel removal arms 36 which are attached to a pivot wheel 43a with a toothed drive and can be pivoted back and forth about a pivot axis 35 in a pivoting direction S. The removal arms 36 are attached to the pivot wheel 43a by means of a bearing 37. These are attached to the underside of the telescopic tube 28 by means of a bearing 37, on which the pivot wheel 43a and a deflection toothed wheel 43b are mounted. The pivot wheel 43a or the removal arms 36 is or are drivable by means of a release mechanism, e.g. electrically or by a release spring.

The removal arms 36 have a free end 38. A magnet 39 is attached to each free end.

The container holding device 30 has a clamping element 40 with a gripper 40a and a toothed drive 43c, a cable pull mechanism with a pull cable 41 and means for actuating (not shown) the pull cable 41. The clamping element 40 and the pull cable 41 are arranged inside the telescopic tube 28. The means for actuating the pull cable 41 comprise a handle element arranged outside the housing. A stop element 45 in the form of a stop disc is also attached to the pull cable 41 on a side of the projection 44 provided on the telescopic tube 28 facing away from the clamping element 40, which serves to prevent the clamping element from being pulled out of the telescopic tube 28. Instead of a stop disc, for example, a simple button provided in the pull cable 41 can also form the stop element 45.

The gripper 40a is arranged to move back and forth within the tube segment 28a between a receiving position and a clamping position. In the receiving position, the gripper 40a is located in the region of the conical inner tube surface 34, with a clamping region 42 aligned with the recess 34 in the tube.

The container removal device 29 is aligned with the position of the storage device 14, in particular with the position of the removal compartment 21, and with the end wall 32 of the tube segment 28a, so that the removal arms 36 are pivotable between a removal position and a holding position.

In the removal position, the removal arms 36 each rest with the magnet 39 against the metal plate 8 of the container 1 provided in the removal compartment 21, so that the container 1 held resiliently in the removal compartment 21 is held in place by the removal arms 36 by the magnet-metal plate connection. As explained, the metal plate 8 is pushed onto the holding pin 7 up to the rim 4 and locked to it. By pivoting the removal arms 36, the container 1 thus contacted and attached to the magnet 39 can be pulled out of the removal compartment 21 in a removal direction E and brought into the holding position. When pivoting into the holding position, the holding pin 7 can be inserted from below into the conical inner tube surface 34 and thus between the grippers 40a which are aligned with it. For the time being, however, the container 1 is only held by the magnets 39.

By pulling back the pull cable 41, the gripper 40a can be moved into the rear area of the tube 28a, whereby the gripper 40a passes the tapered area 33 and thereby the gripping jaws are closed around the holding pin 7 and the latter is clamped or can be held against the end wall 32. The return of the removal arms 36 takes place simultaneously via the toothed wheel 43b and the toothed drive 43c.

In this position, the container 1 can be held behind a dog by means of the telescopic tube 28 while the dog is defecating, in order to collect the defecation with the container 1 even before the defecation touches the ground.

By pulling on the pull cable 41, the gripper 40a can be moved even further to the rear of the tube 28a until the clamping element 40 stops against the projection 44. In the process, the elastic element 6 is pulled out of the rim 4 through the metal plate 8 resting against the end wall 32, whereby the receiving opening 5 is pulled ever closer. During the closing process, the elastic element 6 is simultaneously locked relative to the rim 4 by means of the spring element 12.

When fully extended, the telescopic tube 28 preferably has an overall length of 500 to 1000 mm, more preferably of 600 to 800 mm, in particular of approximately 730 mm. This makes the device 27 convenient to handle by most dog owners. The diameter of the rim 4 of the unfolded container 1 is preferably in the range of 120 to 160 mm, more preferably about 140 mm. The metal plate 8 advantageously has a length of about 40 mm measured along the cutouts 11.

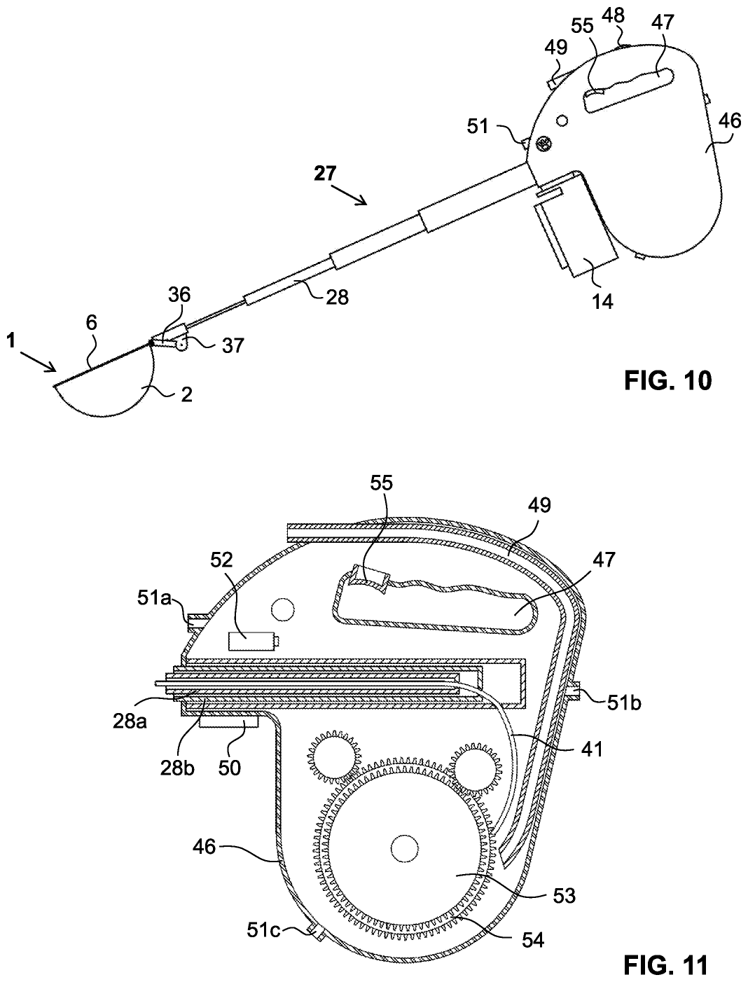

FIGS. 10 to 13 show a possible embodiment of a roller dog leash with a device 27 according to the invention for receiving and handling excrements. The roller dog leash has a housing 46 in which the device 27 for receiving and handling excrements is integrated. The housing 46 has a handle 47 formed thereon in the form of a through opening. Within this through-opening, i.e. in the area of the handle 47, a switch 48 is arranged for actuating the mechanism for extending and retracting the telescopic tube 28. The telescopic tube 28 can thus be extended and retracted by the user by actuating the switch 48.

As will be explained below, when the telescopic tube 28 is extended, a container 1 is automatically pulled out of the storage device 14, unfolded and brought forward to the ready position shown in FIG. 10 by means of the removal arms 36. When the telescopic tube 28 is retracted, the receiving opening 5 of the container 1 is automatically pulled closed by the grippers 40a of the container holding device 30 gripping and retracting the holding means 7, and at the same time the removal arms 36 of the container removal device 29 are brought back into the removal position. The entire function of the telescopic tube 28, the container removal device 29 and the container holding device 30 can thus be controlled and operated by means of a single switch 48.

The drive for retracting and extending the telescopic tube 28 and thus also for controlling the container removal device 29 and the container holding device 30 is shown in FIG. 11. In particular, it has a pull cable drum 54 which can be driven by means of an electric motor not shown in the figure. The direction of rotation of the electric motor and thus of the pull cable drum 54 can be controlled by means of the switch 48. The pull cable drum 54 is used to wind and unwind the pull cable 41, which, as shown in FIG. 11, extends out of the telescopic tube 28 in the end region of the housing and is guided from there to the pull cable drum 54 and wound onto it.

In the embodiment shown here, the pull cable 41 is designed as a combined pull and compression cable, which means that the pull cable 41 can be used not only to exert a pulling force against the direction A, but also to exert a push force along the pull-out direction A. Accordingly, the pull cable 41 has a certain stiffness.

To extend the telescopic tube 28, the pull cable 41 is unwound from the pull cable drum 54, causing the stop element 45 attached to it to strike forward against the radial projection 44, thereby moving the foremost tube segment 28a forward, i.e. away from the housing 46. To retract the telescopic tube 28, the pull cable is wound onto the pull cable drum 54 and thereby pulled into the housing 46. As a result, the clamping element 40 strikes rearwardly against the radial projection 44 and correspondingly pulls the foremost tube segment 28a rearwardly, that is, toward the housing 46.

The function of the container holding device 30, i.e. the automatic clamping of the holding means 7 by the grippers 40a when the pull cable 41 is pulled back, has already been described above.

The action of the pull cable 41 on the container removal device 29 takes place, as also described above, via the toothed drive 43c, the deflection toothed wheel 43b and the pivot wheel 43a. In the removal position, i.e. when the telescopic tube 28 and the pull cable 41 are fully retracted towards the housing 46, the mutual engagement of the toothed drive 43c, the deflection toothed wheel 43b and the pivot wheel 43a prevents the removal arms 36 from folding forward against a spring force.

The removal arms 36 are in fact subjected to a spring force in the direction of the removal position. The associated spring, which is not shown in the figures, can be a simple torsion spring, for example. When the pull cable 41 is unwound from the pull cable drum 54 to extend the telescopic tube 28, the removal arms 36 automatically fold forward due to the spring force. The container 1 attached to the magnets 39 via the metal plate 8 is thereby pulled out of the storage device 14 and unfolds. When the pull cable 41 is subsequently retracted into the housing 46, the removal arms 36 are folded back again into the removal position due to the mutual engagement of the toothed drive 43c, the deflection toothed wheel 43b and the pivot wheel 43a, while the grippers 40a clamp the container 1.

The deflection toothed wheel 43b advantageously has a freewheel in such a way that the mutual engagement of the toothed drive 43c, the deflection toothed wheel 43b and the pivot wheel 43a is effective during a movement of the toothed drive 43c relative to the pivot wheel 43a against the pull-out direction A (i.e. during the retraction of the pull cable 41) and leads to a corresponding folding of the extraction arms 36 backwards against the spring force. In contrast, when the toothed drive 43c moves relative to the pivot wheel 43a along the pull-out direction A (i.e. when the pull cable 41 is moved out of the housing 46), the mutual engagement of the toothed drive 43c, the deflection toothed wheel 43b and the pivot wheel 43a is advantageously ineffective due to the freewheel. The removal arms 36 are then automatically folded forwards or held in their holding position due to the spring force.

As shown in FIG. 11, a line drum 53 is also arranged in the housing 46, which retracts the dog line not shown in the figures in a known manner by means of a retraction mechanism or releases the line when a certain tension is applied. The leash drum 53 is preferably lockable by the user by means of a button 55 if required, in order to prevent further pulling out of the leash by the dog. In order to optimally utilize the space in the housing 46, the leash drum 53 and the pull cable drum 54 are preferably arranged concentrically next to each other, as shown in FIG. 11. The line extends in the housing 46 through a roller line guide 49 and is guided outwards above the telescopic tube 28.

In order to supply electrical power to the electric motor provided for driving the pull cable drum 54, at least one energy storage device 52 is provided in the housing 46. The energy storage device 52 may be one or more batteries, in particular rechargeable batteries. According to a further development of the invention, a means for energy recovery, i.e. an electric generator or dynamo, may be provided to charge the battery(ies) when the roller line is pulled out. The electrical generator is shown in FIG. 11 in the form of a small gear wheel which engages an external gear provided on the line drum 53.

The housing 46 of the present embodiment has lamps 51a, 51b and 51c. The lamps 51a, 51b and 51c are each shown in the form of a recess provided in the housing 46 and each have a light source, for example in the form of an LED. The lamp 51a faces forward and is used to illuminate the path. The lamp 51c is directed downwards to illuminate the immediate surroundings. The lamp 51b, which preferably emits a red light, serves for the safety of the dog owner and is directed to the rear. The lamps 51a, 51b and 51c are advantageously supplied with electrical energy via the battery 52.

Further, an indicator lamp may be provided on the housing 46 to indicate to other dog owners whether the user of the device 27 has time to let the dog play with another dog or is in a hurry and does not want to be disturbed. The indicator lamp, which is not shown in the figures, comprises a light source, for example in the form of an LED. The indication can be in particular colored, whereby for example green can mean “I have time, the dog may play” and red can mean “I am in a hurry and do not want to be disturbed”. The indicator lamp can also be supplied with electrical energy via the battery 52.

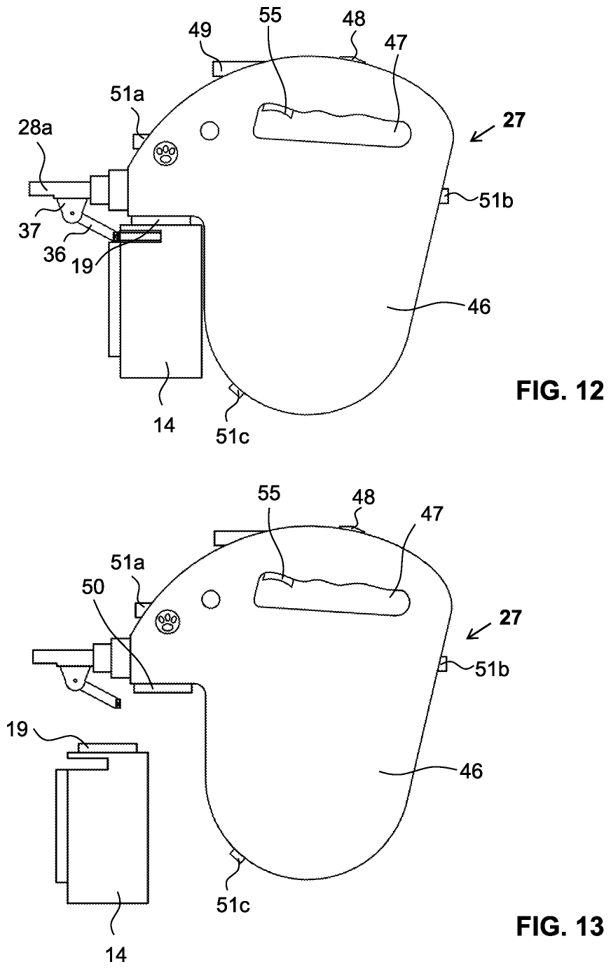

In FIGS. 12 and 13 the device 27 is shown in each case with the telescopic tube 28 fully retracted. In FIG. 12 a storage device 14 filled with containers 1 is attached to the device 27 by means of the bayonet catch 19, 50 and is thus ready for use. In FIG. 13, on the other hand, the storage device 14 is removed from the device 27 after all the containers 1 contained therein have been used. The empty storage device 14 can now be replaced with a new, filled storage device 14.

In the following, the functionality of the device 27 according to the invention is described by way of example on the basis of the above embodiment.

In the initial position, the removal arms 36 are ready in their removal position with the magnets 39 contacting the metal plate 8 to remove the container 1 from the removal compartment 21 (FIGS. 3 and 4);

When the telescopic tube 28 is extended, the removal arms 36 pull the container 1 out of the removal compartment 21 by means of the magnet-metal plate connection;

In the process, the container 1 and in particular its elastic ring 6 unfolds;

At the same time, the grippers 40a are moved into their receiving position on the end wall 32 of the tube 28a and the removal arms 36 are pivoted by in the pivoting direction S and brought into their holding position on the end wall 32 of the tube 28a;

When the container 1 is positioned at the front of the tube 28a, the holding pin 7 is located between the gripping jaws of the gripper 40a (FIG. 6);

The removal arms 36 are pivoted back to their removal position, causing the gripper 40a to move and clamp the holding pin,

The clamping element 40 or gripper 40a is operated by the pull cable 41 and pulled backwards, compressing the gripper 40a as it passes the tapered area 33;

This pulls the holding pin 7 together with the elastic element 6, which is pulled out of the rim 4, into the tube 28, thereby contracting the receiving opening 5 (FIG. 9);

When the pull cable 41 is released, the container 1 falls down and can thus be disposed of without ever having touched the container 1.

The invention is not limited to the illustrated and described embodiments, but also encompasses all embodiments having the same effect within the meaning of the invention. It is expressly emphasized that the embodiments are not limited to all features in combination, rather each individual sub-feature may also have inventive significance in isolation from all other sub-features.

1. A container for receiving and disposing of excrements, the container comprising:
a bag-shaped container wall with a bottom and a rim opposite the bottom;
a receiving opening formed by the rim;
an elastic elastic element provided on the rim for stretching open the receiving opening and for stiffening the rim; and
a device for closing the receiving opening,
wherein the rim is closable by pulling on the elastic element.

2. The container according to claim 1, wherein
the device for closing the receiving opening has a holding element connected to the elastic element, and a locking element provided on the holding element, wherein, a tensile force pointing away from the elastic element in the radial direction is applied to the holding element, the elastic element is moved away from the rim by pulling on the holding element relative to the locking element and is thereby be locked by the locking element.

3. The container according to claim 2, wherein
the holding element is a pin which is firmly connected to the elastic element and extends radially away therefrom.

4. The container according to claim 2, wherein
the locking element has two opposing elastic spring elements, each with an end wall arranged at a free end of the spring element, the end walls shaped in such a way that together they form a recess for the holding element to be inserted through, the recess dimensioned in such a way that when the end walls are pushed onto the holding element, the end walls are bent back in a manner that the end walls lock the holding element.

5. The container according to claim 4, wherein
in the assembled state of the container, the locking element is pushed onto the holding element as far as the rim.

6. A storage device for receiving, holding, and providing a container for receiving excrements, the storage device comprising:
a housing with a housing interior formed by a wall, a bottom and a lid,
wherein one or more containers are received or are receivable in the interior,
wherein the wall has a removal compartment accessible from the outside for automatically providing one of the containers.

7. The storage device according to claim 6, wherein
the wall comprises a first recess running parallel to the lid, which is located in front of the removal compartment and through which the container is removable from the removal compartment.

8. The storage device according to claim 7, wherein
the wall comprises a second recess extending perpendicularly away from the first recess, and wherein a holding element of each container located in the interior is guidable in the second recess.

9. The storage device according to claim 8, wherein
the wall comprises a cover which projects from the wall and is arranged above the second recess in such a way that only the holding element of a container arranged in the removal compartment is accessible from the outside.

10. The storage device according to claim 6, wherein
the storage device comprises a reloading device by means of which containers located in the interior are automatically conveyed in the direction of the removal compartment, so that one of the stored containers are always provided at the removal compartment.

11. A device for receiving and handling excrements, the device comprising:
a storage device for providing a container;
an extendable and retractable tube arrangement;
a container removal device for automated removal of the container from the storage device and conveyance of the container into a container holding device; and
the container holding device for holding the container on an end wall of the tube arrangement and pulling the container closed.

12. The device according to claim 11, wherein
the tube arrangement comprises a plurality of tube segments which are connected to one another and are extendable from a device housing in a pull-out direction A and retractable again, the foremost tube segment, as seen in the pull-out direction A, comprising an end wall, an inner tube surface tapering conically from the end wall counter to the pull-out direction A as far as a tapered region, and a recess on its underside in the region of the conical inner tube surface.

13. The device according to claim 11, wherein
the container holding device comprises a clamping element with at least one gripper and a cable pulling mechanism with a pull cable which can be actuated, and wherein the clamping element and the pull cable are arranged reciprocally displaceable within the tube arrangement between a receiving position, in which the gripper is located in the region of the conical inner tube surface with a clamping region aligned with the recess in the tube, and a clamping position in which the gripper is displaced into a rear region of the tube in a clamping manner with respect to the holding pin.

14. The device according to claim 13, wherein
the container removal device has one or more parallel removal arms which are pivotable back and forth about a pivot axis in a pivoting direction and which each comprise a magnet at a free end facing away from the pivot axis, the container removal device being adapted to the position of the removal compartment and to the end wall of the tube segment so that the removal arms are pivotahle between a removal position in which the removal arm rests in each case with the magnet against the locking element of the container which is provided in the removal compartment, and wherein the holding element engages through a through hole of the magnet, and a holding position in which the holding element is insertable from below into the conical inner tube surface in the clamping region of the gripper.

15. A roller dog leash, comprising:
a dog leash which is installed in a housing and which is automatically releasable for unrolling and rolling up again, wherein
the housing comprises a device for receiving and handling excrements, the device comprising:
a storage device for providing a container;
an extendable and retractable tube arrangement;
a container removal device for automated removal of the container from the storage device and conveyance of the container into a container holding device; and
the container holding device for holding the container on an end wall of the tube arrangement and pulling the container closed.

16. The device according to claim 14, wherein the container removal device has two parallel removal arms.
